(19) United States
(12) Patent Application Publication
(10) Pub. No.: US 2009/0183974 A1
(43) Pub. Date: Jul. 23, 2009

(54) Drive Arrangement Having a Common Drive Device for a Plurality of Switchgears of an Electric Switching Device

(75) Inventors: Lutz-Rüdiger Jänicke, Mahlow (DE); Christian Wallner, Erlangen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/373,223

(22) PCT Filed: Jul. 11, 2007
(86) PCT No.: PCT/EP2007/057086

§ 371 Date: Jan. 9, 2009

(30) Foreign Application Priority Data
Jul. 14, 2006 (DE) 10 2006 033 515.5

(51) Int. Cl. H01H 9/00

(52) U.S. Cl. 200/17 R

(57) ABSTRACT

A drive configuration includes a common drive device and driver elements. The driver elements interact with drive elements in order to transmit a drive movement generated by the drive device to movable contact pieces of switching poles or switchgears of an electric switching device. At least one of the switching poles or switchgears has a first driver element and a second driver element, in which the first driver element serves for the generation of a switching-on movement, and the second driver element serves for the generation of a switching-off movement.

The invention relates to a drive arrangement with a common drive device for a plurality of switching poles of an electrical switching device, the drive arrangement having a moving part with driver elements for transmitting a movement to drive elements associated with the switching poles.

Such a drive arrangement is known, for example, from the document IPCOM 000124430D published on www.ip.com. Said document describes an apparatus for the controlled switching of inductive and capacitive loads by means of a high-voltage circuit breaker. In order to reduce equalization processes when switching electrical operating means, poles of the high-voltage circuit breaker are switched with a temporal offset with respect to one another. In order to produce a time offset, it is proposed to couple in or out, as necessary, a moving part which is in the form of a coupling rod. It is thus possible to achieve a temporally different movement response when using a common drive device at the individual poles. For the coupling-in and coupling-out, it is provided to use drive elements of different shapes in order to fix different coupling times at the individual switching poles.

Such a configuration of a drive mechanism has the disadvantage that differently shaped drive elements need to be used. Despite the different shapes of the drive elements, it is only possible to a small extent to match the individual coupling times to one another since optimization of, for example, a switch-on operation also brings with it effects on the switching response during a switch-off operation.

Thus, one object of the invention is to specify a drive arrangement of the type mentioned at the outset which allows for simplified adjustment and setting of the switching response of the individual switching poles.

According to the invention, the object is achieved in the case of a drive arrangement of the type mentioned at the outset by virtue of the fact that the drive arrangement has a first and a second driver element for at least one of the switching poles, the first driver element transmitting a switch-on movement and the second driver element transmitting a switch-off movement.

The provision of a first and a second driver element makes it possible to match the transmission response of the drive arrangement for a switch-on operation and a switch-off operation independently of one another. It is thus possible, for example during a switch-on operation, for the contact pieces, which are each capable of moving relative to one another, of the respective switching poles of the electrical switching device to be brought into DC contact with one another at different times. Switching-on therefore takes place in staggered fashion. The reversed isolation of the respective contact pieces from one another during a switch-off operation can take place with different temporal staggering. It can also be provided, for example, that temporal staggering of the switching times of the individual switching poles with respect to one another is provided only in the case of a switch-on operation, while simultaneous opening of the switching contacts of the individual switching poles takes place in the case of a switch-off operation. Furthermore, depending on the use condition of the electrical switching device, it can be provided that the sequence for the contact-making of the switching poles is varied and/or takes place with different temporal staggering. As a result of the two driver elements which are functionally separate from one another, each driver element can be positioned in its position on the moving part individually. Positioning of one driver element in this case does not necessarily bring about a change in the transmission response of the other driver element. In order to achieve an arrangement in which even greater adaptability is possible, it can be provided that a first drive element is associated with the first driver element and a second drive element is associated with the second driver element. Thus, the position of the drive elements can also be fixed individually, if necessary.

Advantageously, it can also be provided that the same drive element feels the first and the second driver element. Owing to the use of one and the same drive element, the number of moving parts within a kinematic chain of the drive arrangement can be reduced. As a result, the moving masses are reduced and thus the inertia of the entire system is reduced. It is thus possible to control switching operations in a more targeted manner. Furthermore, drive devices can be used which have a reduced power consumption.

When using the same drive element for the two driver elements, adjustment can advantageously be carried out by means of a change in position of the driver elements on the moving part. This prevents a situation in which, owing to an excessively high number of parameterizable variables, a factory-preset configuration is changed to an excessive degree. Thus, even in the case of erroneous setting and adjustment of the drive arrangement, at least a minimum functional capacity of the drive arrangement can be ensured. When restricting the setting possibilities, the positions of the driver elements can be reliably fixed, for example by means of simple adjustment aids such as gauges. Fine adjustment which may be required can be carried out by appropriately trained technical personnel, if required.

Advantageously, it can also be provided that the drive element is in the form of a fork.

As a result of the use of fork-shaped drive elements, high forces can be transmitted in the case of corresponding shaping of the fork prongs. Furthermore, in the case of corresponding rotatable mounting of the forks, step-up transmission of the movement of a driver element can also take place. For example, a driver element can be moved on a circular path, the driver element entering and withdrawing from a rotatably mounted fork. Given a corresponding selection of the radius of the circular path on which the driver element is moved and a length of the fork prongs which is matched thereto, corresponding step-up or step-down transmission of the movement of the driver element to the rotatably mounted drive element can take place.

Advantageously, given a configuration of the drive element as a fork-shaped drive element, it can be provided that a fork opening is delimited by two fork prongs which are guided parallel to one another, fork prong inner surfaces, which are aligned substantially parallel to one another, being used for making contact with a driver element. Furthermore, however, it can also be provided that the fork prongs with their surfaces which make contact with driver elements are provided with a profile, such that a particular step-up transmission of the movement of the driver elements takes place.

Advantageously, it can be provided that the fork-shaped drive element engages with a fork opening around the moving part.

The drive element and the moving part are guided by virtue of the fact that one engages around the other. As a result, they can be supported against one another. Furthermore, good preconditions are provided for allowing driver elements arranged on the moving part to interact with the drive element. It is also advantageous to provide the fork-shaped drive element with a plurality of fork openings. Advantageously, the fork openings should be arranged transversely with respect to one another. Thus, one fork opening can be used for guidance on the moving part and a further fork opening can be reserved for making contact with a driver element.

Advantageously, it can also be provided that driver elements are arranged on sides of the moving part which face away from one another.

If the driver elements are arranged on sides of the moving part which face away from one another, a movement of the driver elements can be tapped off by the drive elements in a simple manner since the assemblies provided for tapping off the movement can each be arranged spaced apart from one another. Advantageously, the two sides which face away from one another should represent surfaces which are arranged parallel to one another, with the result that the drive elements are aligned identically with respect to an axis, but have different direction senses. Thus, for example when using rotationally symmetrical driver elements, the rotation axes of driver elements arranged on the sides of the moving part which each face away from one another are aligned parallel to one another. A further advantageous configuration can provide that the first and the second driver elements are capable of being adjusted independently of one another within a feeling range of the drive element.

An independent adjustment of the driver elements makes it possible to fix the switch-on response and the switch-off response for the respective switching poles individually. Adjustability within the feeling range of the drive element ensures that a complete switch-on operation or a complete switch-off operation can be implemented by the drive arrangement in each case. In order to ensure the adjustability within the feeling range, it can be provided, for example, to provide corresponding cutouts on the moving part, with the result that the driver elements can be varied in terms of their position only in a limited section. Thus, it can be provided, for example, that the driver elements engage in cutouts and the number of cutouts is limited in such a way that an adjustment within the feeling range of the drive element is necessarily provided.

Advantageously, it can also be provided that the moving part is capable of moving in translatory fashion.

A translatory movement, i.e. a linear movement of the moving part, has the advantage that a change in the position of the driver elements on the moving part influences the time offset of the switching of the individual poles, but without a change in the transmission response of the drive arrangement bringing about, for example, a change in a step-up transmission ratio. As a result, relatively free positioning of the individual driver elements on the moving part is possible. The moving part correspondingly implements a “to and fro” movement, the “to movement” bringing about, for example, a switch-on operation at the switching poles and the “fro movement” bringing about a reversal of the switch-on movement, i.e. a switch-off movement at the switching poles. In order to produce the translatory movement, an electromagnetic linear drive can be provided, for example, which drives the moving part. However, it can also be provided that the drive device outputs a rotary movement, and the rotary movement is converted into a linear movement via a slider-crank mechanism. In order to tap off the driver elements, which are moved along with the moving part likewise on the movement path thereof, it can be provided that the drive elements are mounted fixed in position and rotatably and the translatory movement of the moving part is converted into a rotary movement. This has the advantage that a change in the movement characteristic at the drive element takes place. When using a, for example, fork-shaped drive element which is mounted rotatably and fixed in position, a step-up transmission ratio is continuously changed in the event of a driver element meshing with the fork opening during a slide-through operation since, owing to the rotary movement, an effective lever arm on the fork-shaped drive element changes.

A further configuration of the invention can provide that at least one of the driver elements is a bolt.

Driver elements in the form of bolts can be produced in large numbers. In this case, an outer surface of the bolt can come into contact with a drive element so as to transmit a movement. It is advantageous to connect the bolt at the end to the moving part. Thus, for example, it can be provided that the bolts are connected at a rigid angle to the moving part. In order to make an adjustment possible, this rigid-angle fastening should be repeatedly detachable. Suitable for this purpose are in particular screw-type connections, via which the bolts are secured in their positions. However, it can also be provided that the bolts are cohesively connected to the moving part or are an integral component of the moving part. For the cohesive connection it is possible to use, for example, a welding or soldering process or other suitable connection processes.

A further advantageous configuration can provide that in each case a first and a second driver element is associated with each of the switching poles.

By virtue of the fact that a first and a second driver element are associated with each of the switching poles of a multipole electrical switching device, a group of first driver elements and a group of second driver elements are formed in the working arrangement. The respective first and second driver elements can be adjusted individually. As a result, a high degree of flexibility as regards temporal staggering of switching operations at the individual switching poles of the electrical switching device is provided.

An exemplary embodiment of the invention is shown schematically below in figures and will be described in more detail below.

In the figures:

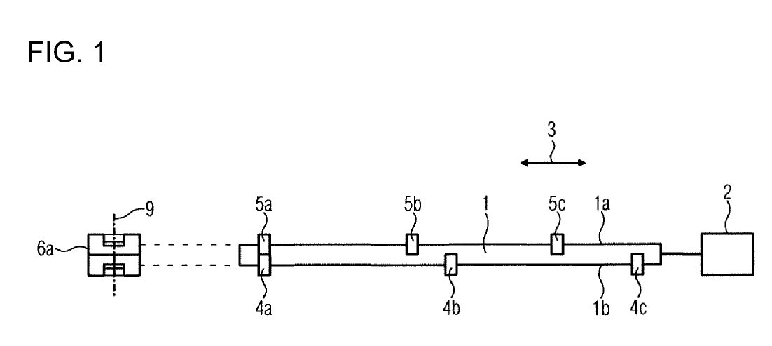

FIG. 1 shows a plan view of a moving part with driver elements and a drive element arranged with an offset, and

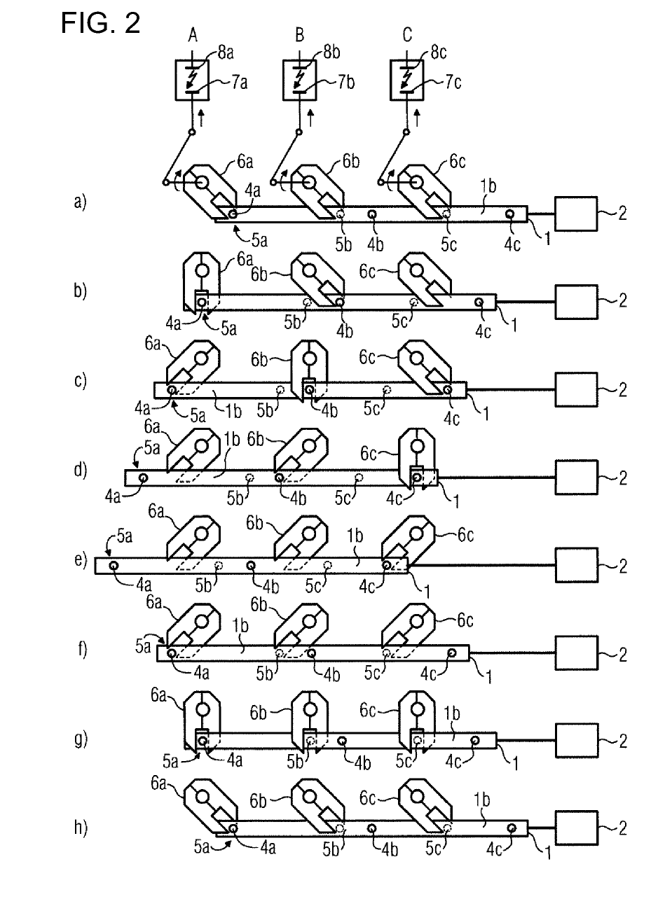

FIG. 2 shows, in sequences a), b), c), d), e), f), g), h), the profile of a switch-on and a switch-off movement of a drive arrangement.

FIG. 1 show a moving part 1 of a drive arrangement. The moving part 1 is in the form of a coupling rod, which has a rectangular profile. The moving part 1 is linearly displaceable by means of a drive device 2 in the direction of a double arrow 3. Driver elements 4a,4b,4c,5a,5b,5c are arranged on sides 1a,1b which face away from one another. The sides 1a,1b of the moving part 1 which face away from one another are in each case arranged vertically with respect to the plane of the drawing in FIG. 1.

The driver elements 4a,b,c,5a,b,c are in the form of bolts and are let into the sides 1a,1b which face away from one another. As a result of a change in the position of the driver elements 4a,b,c,5a,b,c on the moving part 1, the switching response of the drive arrangement can be set. At that end of the moving part 1 which faces away from the drive device 2, a plan view of a drive element 6a is illustrated schematically. The drive element 6a is in the form of a fork, with the result that driver elements 4a and 5a mesh with a fork (cf. FIG. 2). Fork prongs of the drive element are arranged so as to be spaced apart from one another and form a further fork, with the result that the moving part 1 can slide through between the prong. In the movement direction (double arrow 3) of the moving part 1, the fork prongs are arranged offset with respect to one another. A pivot axis 9 is arranged transversely with respect to the movement direction of the moving part 1. In the direction of the pivot axis, the fork is formed as a result of the offset of the fork prongs. The fork-limiting surfaces are used for making contact with the driver elements 4a,5a.

FIG. 2 shows, in sequences a), b), c), d), e), f), g), h), the order of a switch-on movement and a switch-off movement of the drive arrangement. Symbolically, switching poles A,B,C of an electrical switching device are depicted. The driver elements 4a,4b,4c facing the viewer are illustrated by means of solid lines in FIG. 2. In contrast, driver elements 5a,5b,5c arranged on that side of the moving part 1 which faces away from the viewer are symbolized by interrupted lines. In this case it should be noted that, owing to the alignment with the same axis of the driver elements 4a,5a associated with the switching pole A, the covered driver element 5a cannot be seen in FIG. 2.

The drive elements 6a,6b,6c are mounted rotatably. In order to illustrate a movement, the fork ends of the drive elements 6a,6b,6c are separated from one another by in each case a solid line running through the axis of rotation of the drive elements. For example, the fork-shaped drive elements 6a,6b,6c are each arranged at a rigid angle on a rotatably mounted shaft, with the result that a movement transmitted by means of the moving part 1 from the drive device 2 is also transmitted to the corresponding drive shaft. Directly movable contact pieces of the individual switching poles can then be arranged on the drive shaft. For example, pivotable blade contacts can be driven directly. However, it can also be provided that a conversion of the rotary movement of the shaft into a linear movement takes place via slider-crank mechanisms in order to bring about a displacement of a movable contact piece.

In sequence a) in FIG. 2, the switching poles A,B,C of an electrical switching device are illustrated symbolically. The switching poles A,B,C each have a movable contact piece 7a,7b,7c and a fixed contact piece 8a,8b,8c.

In sequence a), an off position of the switching poles A,B,C of an electrical switching device is illustrated. In the event of a switch-on operation, a movement is generated by the drive device 2, which movement moves the moving part 1 on from the drive device 2 in linear fashion. Owing to the positioning of the driver element 4a, the driver element 4a travels against a fork prong of the drive element 6a. The driver elements 4b and 4c are correspondingly spaced apart, with the result that they cannot as yet interact with the correspondingly associated drive elements 6b and 6c. This first of all results in the switching pole A switching on.

In sequence b) in FIG. 2, a partial movement of the movable contact piece 7a of the switching pole A has already taken place. The end position of the movable contact piece 7a has not yet been reached, however. The driver element 4b, which is associated with the drive element 6b of the switching pole B, travels against a fork prong of the drive element 6b. A movement of the movable contact piece 7b for generating a switch-on movement at the switching pole B is directly imminent. In sequence c) in FIG. 2, the switch-on operation at the switching pole A has concluded, i.e. the drive element 6a of the switching pole A uncouples from the associated driver element 4a. The switch-on operation at the switching pole B is still in motion while the driver element 4c is just coupled into the drive element 6c of the switching pole C. In sequence d), it can be seen that the switch-on operation at the switching pole A has concluded, i.e. the drive element 6a associated with the switching pole A is at rest. Owing to the further progress of the movement of the moving part 1, the driver element 4a moves away from the associated drive element 6a of the switching pole A. At the switching pole B, the drive element 6b is decoupled from the associated driver element 4b, i.e. the switch-on operation has also concluded at the switching pole B, while the switch-on operation is still being performed at the switching pole C. In sequence e) in FIG. 2, the end position of all of the drive elements 6a,6b,6c of the drive arrangement in the setting of the switching poles A,B,C is illustrated, i.e. in this position the movable contact pieces 7a,7b,7c are pushed against the fixed contact pieces 8a,8b,8c and are in DC contact with them. A circuit within a polyphase AC voltage system could be closed, with a temporal offset between the times at which contact is made in the switching poles A, B and C taking place. First, the switching pole A switches on, then the switching pole B switches on and finally the switching pole C switches on. By correspondingly varying the positions of the driver elements 4a,4b,4c, an alternative temporal staggering, i.e. both in the sequence of the contact-making of the switching poles and a variation of the temporal gaps between the contact-making operations of the individual switching poles A,B,C with respect to one another, is possible. The driver elements 4a,4b,4c, which are arranged on that side 1b of the driver element 1 which faces the viewer in FIG. 2, form a group of first driver elements, which are used for the switching-on operation. Each of the drive elements 6a,6b,6c interacts in each case with a separate driver element 4a,4b,4c in a switch-on operation. Starting from the switch-on position of the switching poles A,B,C of the sequence e) in FIG. 2, the text which follows describes the action of the movable contact pieces 7a,7b,7c of the switching poles A,B,C being moved over from their switch-on positions into their switch-off positions. The driver elements 5a,5b,5c which are used for switching off the switching poles A,B,C are now used. The driver elements 5a,5b,5c are arranged on that side of the moving part 1 which faces away from the viewer in figure 2. They are symbolized by corresponding interrupted lines. In the event of a switch-off operation, the three switching poles A,B,C are intended to switch off at the same time. Therefore, the arrangement of the driver elements 5a,5b,5c is selected such that they enter the fork openings of the corresponding drive elements 6a,6b,6c of the switching poles A,B,C at the same time and interact with the fork prongs of the drive elements 6a,6b,6c, which fork prongs are positioned on the side which is partially covered by the moving part in FIG. 2, at the same time (see sequence f) in FIG. 2). In sequence g), it can be seen that all of the drive elements 6a,6b,6c are deflected out of their switch-on positions (sequence e)) at the same time. In sequence g), precisely the performance of the movable contact pieces 7a,7b,7c of the switching poles A,B,C being moved from their switch-on positions into their switch-off positions is illustrated. In sequence h), the switch-off operation has concluded, i.e. the movable contact pieces 7a,7b,7c have assumed their switch-off positions. The driver elements 5a,5b,5c are decoupled from the drive elements 6a,6b,6c at the same time. The switch-off position illustrated in sequence h) corresponds to the switched-off position shown in sequence a) in FIG. 2, i.e. the switching poles A,B,C are ready for a switch-on operation to be carried out.

As can be seen in FIG. 2, the fork prongs of the fork-shaped drive elements 6a,6b,6c are shaped in such a way that different driver elements, namely firstly driver elements 4a,4b,4c for the switch-on operation and secondly driver elements 5a,5b,5c for the switch-off operation, can be felt on both sides of the moving part 1. Owing to this arrangement it is possible to provide the moving part 1 in any desired width, with the result that the fork prongs of the drive elements 6a,6b,6c in terms of their depth can be spaced apart from one another as far as desired, with respect to FIG. 2. In a projection, however, they advantageously always assume a fork shape, with the result that a fork opening is formed in which driver elements can engage. A further fork of the drive elements 6a,6b,6c engages around the moving part 1.

In addition to the linear movement of a moving part shown in FIG. 2, said moving part can also be mounted such that it is capable of a rotary movement, for example, and can transmit a drive movement in the form of a rotary movement to the drive elements using driver elements.

1-9. (canceled)

10. A drive configuration for an electrical switching device having a plurality of switching poles with associated drive elements, the drive configuration comprising:
a common drive device for the plurality of switching poles; and
a moving part having driver elements for transmitting a movement from said common drive device to the drive elements associated with the switching poles;
said driver elements including first and second driver elements for at least one of the switching poles, said first driver elements transmitting a switch-on movement and said second driver elements transmitting a switch-off movement.

11. The drive configuration according to claim 10, wherein the same one of the drive elements senses said first and second driver elements.

12. The drive configuration according to claim 10, wherein the drive elements are fork-shaped.

13. The drive configuration according to claim 12, wherein the fork-shaped drive elements have a fork opening engaging around said moving part.

14. The drive configuration according to claim 10, wherein said driver elements are disposed on sides of said moving part facing away from one another.

15. The drive configuration according to claim 11, wherein said first and second driver elements are adjustable independently of one another within a sensing range of the one drive element.

16. The drive configuration according to claim 10, wherein said moving part is movable in a translatory manner.

17. The drive configuration according to claim 10, wherein at least one of said driver elements is a bolt.

18. The drive configuration according to claim 10, wherein said driver elements include first and second driver elements associated with each respective one of the switching poles.
